(19) United States
(12) Patent Application Publication
(10) Pub. No.: US 2010/0265269 A1
(43) Pub. Date: Oct. 21, 2010

(54) PORTABLE TERMINAL AND A DISPLAY CONTROL METHOD FOR PORTABLE TERMINAL

(75) Inventor: Nobuhiro MATSUDA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, TOKYO (JP)

(21) Appl. No.: 12/564,321

(22) Filed: Sep. 22, 2009

(30) Foreign Application Priority Data
Apr. 17, 2009 (JP) P2009-101436

(51) Int. Cl. G09G 5/00

(52) U.S. Cl. 345/650

(57) ABSTRACT

A portable terminal includes: a display unit configured to display data on a screen; a rotation detecting unit configured to detect rotation of the portable terminal; a touch detecting unit configured to detect touch of the screen of the display unit; and a display control unit configured to, when rotation is detected by the rotation detecting unit and touch is detected by the touch detecting unit, revolve display content displayed on the screen in conformity with the rotation of the portable terminal.

According to the portable terminal, by allowing the user to specify an axis of rotation when changing the screen display direction, it is possible to prevent a change that is against the intention of the user, and also to change the display direction in a state in which a portion that the user wants to display among the display contents remains displayed.

### CROSS-REFERENCE TO RELATED APPLICATIONS

This application is based upon and claims the benefit of priority from the prior Japanese Patent Application No. 2006-297989 filed on Nov. 1, 2006; the entire contents of which are incorporated herein by reference.

### BACKGROUND OF THE INVENTION

1. Field of the Invention

The present invention relates to a portable terminal and a display control method for a portable terminal that include a touch screen and that switches a display direction of a screen of the touch screen in response to an acceleration. More particularly, the invention relates to a portable terminal that rotates a screen by taking a tap position on the screen as an axis of rotation when switching the screen display direction.

2. Description of the Related Art

In recent years, there has been an increase in the number of portable terminals that are equipped with, for example, an acceleration sensor for controlling a screen display. In such types of portable terminals, it is possible to determine the orientation of the terminal based on an acceleration that is applied to the terminal, and change the display direction of the screen. There are, for example, three kinds of screen display directions: vertical, horizontal for right-handed users, and horizontal for left-handed users. However, if the size of the screen in the vertical direction and the size of the screen in the horizontal direction differed significantly, there had been the risk that a portion that the user had been gazing at the screen would no longer be displayed when the screen display direction was changed.

Consequently, a personal digital assistant has been proposed that can appropriately change the display contents when the state of a display part is changed (see Patent Document 1 (Japanese Patent Laid-Open No. 2008-118286)). According to this personal digital assistant, when a main display part is changed from a vertically long state to a horizontally long state, a display area that is extracted for displaying on the main display part is changed so that a point at a left upper end is common to the display area before the change and the display area after the change.

Further, a portable terminal including a touch screen (an electronic component that is equipped with both a display function and an input function by combining a display apparatus such as a liquid crystal panel and a locator device such as a touch pad) is provided with an interface that, for example, rotates the display contents of a screen 90 degrees clockwise (rotates the display contents counterclockwise for a left-handed rotation) when a user moves the displayed contents by touching the screen with a rightward motion in a half rotation while the screen display direction is fixed.

In a method that changes a screen display direction based on an acceleration that is applied to a portable terminal, the screen display direction is changed based only on detection information of an acceleration sensor. Hence, when a user operates the portable terminal while carrying the portable terminal or while performing another action, there is a risk that the screen display direction will be changed against the intention of the user due to the portable terminal swaying or the like.

### SUMMARY OF THE INVENTION

The present invention has been made in view of the above described circumstances and provides a portable terminal and a display control method for a portable terminal that can change a screen display direction based on an acceleration, wherein by the user specifying an axis of rotation when changing the screen display direction, it is possible to prevent a change against the intention of the user and also to change the display direction in a state in which a portion that the user wants to display among the display contents remains displayed.

In order to address the above-described problem, a portable terminal according to the present invention comprises a display unit configured to display data on a screen; a rotation detecting unit configured to detect rotation of the portable terminal; a touch detecting unit configured to detect touch of the screen of the display unit; and a display control unit configured to, when rotation is detected by the rotation detecting unit and touch is detected by the touch detecting unit, revolve display content displayed on the screen in conformity with the rotation of the portable terminal.

And a display control method for a portable terminal according to the present invention comprises a rotation detecting step for detecting rotation of the portable terminal; a touch detecting step for detecting touch of a screen of the portable terminal; and a setting step making a setting as to whether a connection is permitted to be established at the communication step, on the basis of the state acquired at the acquiring step; and a display control step for, when rotation is detected at the rotation detecting step and touch is detected at the touch detecting step, revolving display content displayed on the screen in conformity with the rotation of the portable terminal.

### BRIEF DESCRIPTION OF THE DRAWINGS

An embodiment of the present invention will be described in detail based on the following figures, wherein:

FIG. 1 is an perspective view of a portable terminal (portable telephone) according to the present invention;

FIG. 2 is a block diagram showing functions of the portable terminal (portable telephone) according to the present invention;

FIG. 3A is a view that shows a state in which the portable terminal (portable telephone) according to the present invention is used in a horizontal direction, and FIG. 3B is a view that shows a state in which the portable terminal (portable telephone) according to the present invention is used in a vertical direction;

FIG. 4 is a screen view that shows a display settings screen;

FIG. 5A is a view that shows an example of a screen that is displayed on a touch screen when the portable terminal (portable telephone) according to the present invention is used in the horizontal direction, and FIG. 5B is a view that shows an example of a screen that is displayed on the touch screen when the portable terminal (portable telephone) according to the present invention is used in the vertical direction;

FIG. 6 is a flowchart that illustrates procedures when the portable terminal (portable telephone) according to the present invention performs screen direction control processing;

FIG. 7A is a view that shows an example of a screen when map information is displayed on the touch screen in a state in which the portable terminal (portable telephone) according to the present invention is used in the horizontal direction, and FIG. 7B is a view that shows an example of a screen when map information is displayed on the touch screen in a state in which the portable terminal (portable telephone) according to the present invention is used in the vertical direction;

FIG. 8 is a view that shows, with respect to map information, an example of an area that is displayed on the touch screen when the portable terminal (portable telephone) according to the present invention is used in the horizontal direction, and an example of an area that is displayed on the touch screen when the portable terminal (portable telephone) is used in the vertical direction;

FIG. 9 is a view that shows, with respect to map information, an example of an area that is displayed on the touch screen when the portable terminal (portable telephone) according to the present invention is used in the horizontal direction, and an example of an area that is displayed on the touch screen when the portable terminal (portable telephone) is used in the vertical direction;

FIG. 10 is a view that shows, with respect to map information, an example of an area that is displayed on the touch screen when the portable terminal (portable telephone) according to the present invention is used in the horizontal direction, and an example of an area that is displayed on the touch screen when the portable terminal (portable telephone) is used in the vertical direction; and

FIG. 11 is a view that shows, with respect to spreadsheet information, an example of an area that is displayed on the touch screen when the portable terminal (portable telephone) according to the present invention is used in the horizontal direction, and an example of an area that is displayed on the touch screen when the portable terminal (portable telephone) is used in the vertical direction.

### DETAILED DESCRIPTION OF THE PREFERRED EMBODIMENTS

An embodiment of the portable terminal according to the present invention is described hereunder with reference to the attached drawings. As an example of the portable terminal according to the present invention, a portable telephone 1 is described that comprises an acceleration sensor and a touch screen, and that can change a screen display direction of the touch screen in accordance with an acceleration that is applied to the terminal.

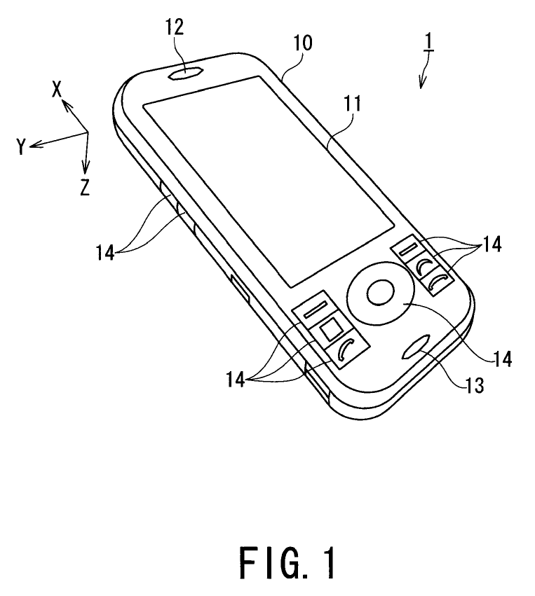

FIG. 1 is an perspective view that shows the portable telephone 1. As shown in FIG. 1, the portable telephone 1 comprises a rectangular tabular case 10. On a surface of the case 10 is provided a touch screen 11 that displays data and also inputs data by contact, a speaker 12 for outputting sound, a microphone 13 for inputting sound, and a plurality of operation keys 14 that input an instruction by being pressed downwards.

The touch screen 11 is a display that comprises both a display function that displays display data including characters or images or the like, and an input function that inputs an instruction by detecting a contact position when a user touches the screen with a finger or a special-purpose pen. The screen of the display is formed, for example, in a rectangular shape. The touch screen 11 is formed by, for example, arranging a plurality of elements for detecting a contact with the screen on a display, and laminating a transparent screen thereon. The method of detecting a contact on the touch screen 11 may be a pressure-sensitive method that detects a change in a pressure, an electrostatic method that senses electric signals based on the static electricity thereof, or may be another method.

The operation keys 14, for example, include a direction key for moving a cursor that is displayed on the touch screen 11 up or down and right or left or for scrolling the screen, a call key for originating a telephone call, an end call key for terminating a telephone conversation, and a short cut key for activating an e-mail function or a web function.

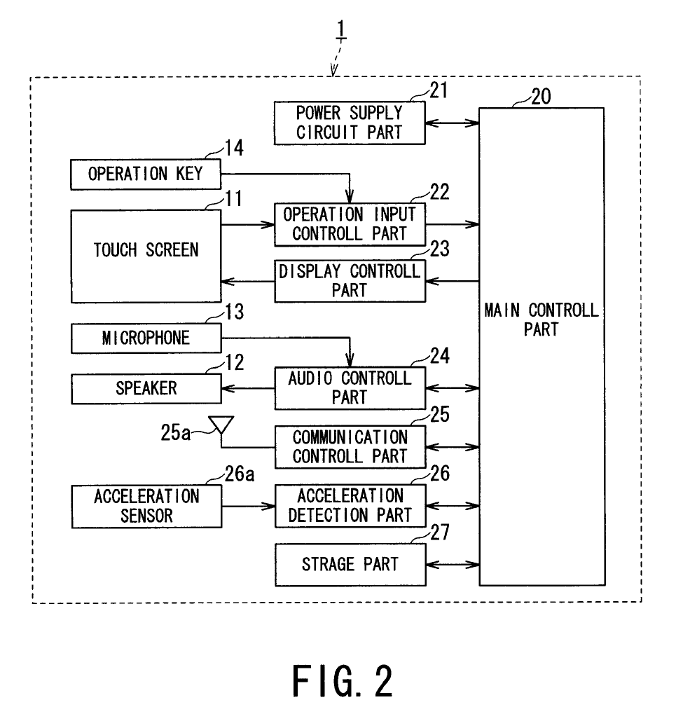

Next, the functions of the portable telephone 1 are described using the block diagram shown in FIG. 2. As shown in FIG. 2, the portable telephone 1 comprises a main control part 20, a power supply circuit part 21, an operation input control part 22, a display control part 23, a sound control part 24, a communication control part 25, an acceleration detection part 26, and a storage part 27. These parts are communicably connected to each other by a bus.

The main control part 20 comprises a CPU (Central Processing Unit) and performs overall control of the portable telephone 1 as well as screen direction control processing that is described later and various other kinds of arithmetic processing and control processing. The power supply circuit part 21 comprises a power supply source (a battery or the like) and, for example, switches an on/off state of the power supply of the portable telephone 1 based on an input through a predetermined operation key 14. When the power supply is on, the power supply circuit part 21 supplies power to each part from the power supply source to enable operation of the portable telephone 1.

The operation input control part 22 comprises an input interface with respect to the touch screen 11. Upon detecting a contact with the touch screen 11, the operation input control part 22 generates a signal indicating the position of that contact and transmits the signal to the main control part 20. The operation input control part 22 also comprises an input interface with respect to the operation keys 14. Upon detecting that an operation key 14 has been pressed, the operation input control part 22 generates a signal that indicates the pressed key and transmits the signal to the main control part 20. The main control part 20 that receives the signal performs various processing based on the signal. The display control part 23 comprises a display interface that displays the touch screen 11. The display control part 23 generates display screen data based on control of the main control part 20 and displays the generated data on the touch screen 11.

The sound control part 24 generates an analog sound signal from sound that is collected at the microphone 13 based on control by the main control part 20, and converts the analog sound signal into a digital sound signal. Further, when the sound control part 24 acquires a digital sound signal, the sound control part 24 converts the digital sound signal to an analog sound signal and outputs the analog sound signal as sound from the speaker 12 based on control of the main control part 20.

Based on control of the main control part 20, the communication control part 25 subjects a reception signal that is received through an antenna 25a from a base station to reverse spread spectrum processing to restore the original data thereof. In accordance with an instruction from the main control part 20, the data is transmitted to the sound control part 24 and output from the speaker 12, or transmitted to the display control part 23 and displayed on the touch screen 11, or recorded in the storage part 27. Further, based on control of the main control part 20, when the communication control part 25 acquires sound data that is collected at the microphone 13, data that is input through the touch screen 11 or the operation keys 14, or data that is stored in the storage part 27, the communication control part 25 performs spread-spectrum processing for such data and transmits the resulting data to a base station via the antenna 25a.

The acceleration detection part 26 comprises an acceleration sensor 26a that detects an acceleration that is being applied to the portable telephone 1. Based on control by the main control part 20, or each time a fixed period of time elapses, the acceleration detection part 26 generates a signal indicating an acceleration that is detected by the acceleration sensor 26a and transmits the signal to the main control part 20.

The storage part 27 comprises a ROM (Read Only Memory), a hard disk, a non-volatile memory, a database, a RAM (Random Access Memory) that temporarily stores data that is used when the main control part 20 performs processing, or the like that stores a processing program or data required for or processing or the like with respect to processing that the main control part 20 performs. Further, it is assumed that a processing program used when the main control part 20 performs screen direction control processing that is described later is, for example, stored in a ROM.

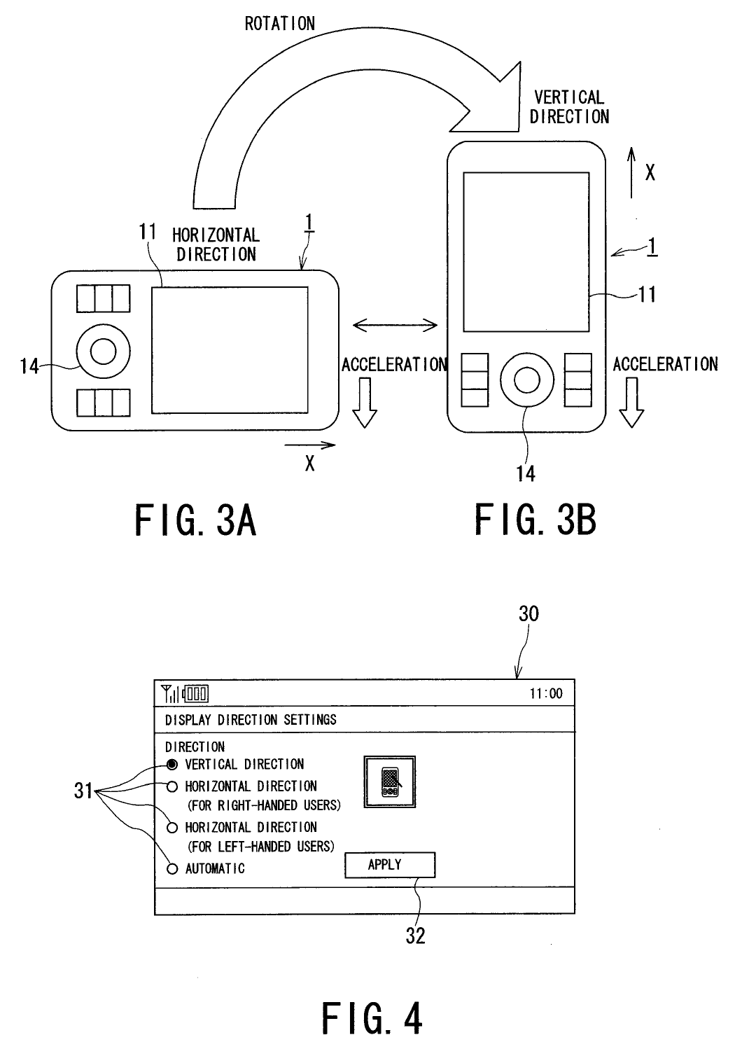

FIG. 3A is a view that shows a state in which the portable telephone 1 is disposed in a horizontal direction, and FIG. 3B is a view that shows a state in which the portable telephone 1 is disposed in a vertical direction. The portable telephone 1 is used when oriented in the horizontal direction (orientation at which the X direction in FIG. 1 is positioned in the horizontal direction) as shown in FIG. 3A, and is also used when oriented in the vertical direction (orientation at which the X direction in FIG. 1 is positioned in the vertical direction) as shown in FIG. 3B. It is therefore desirable that the screen display direction of the portable telephone 1 is changed in accordance with these kinds of usage states.

Therefore, the portable telephone 1 comprises a function that controls the screen display direction based on user settings when displaying a screen on the touch screen 11. FIG. 4 is a screen view that shows a display direction settings screen 30 for setting the screen display direction of the touch screen 11. As shown in FIG. 4, the display direction settings screen 30 comprises a selection column 31 for selecting a display direction and an “apply” button 32 for applying a display direction that is selected in the selection column 31. The selection items for the display direction are, for example, “vertical direction”, “horizontal direction (for right-handed users)”, “horizontal direction (for left-handed users)”, and “automatic”. After selecting any one of the items in the selection column 31 using the touch screen 11, the user sets the screen display direction of the touch screen 11 by selecting the “apply” button 32.

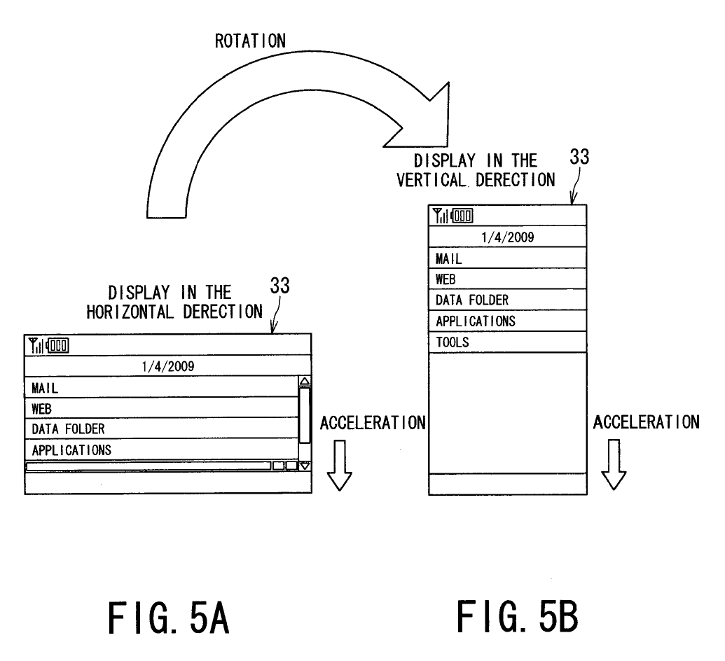

FIG. 5A is a view that shows an example of a screen that is displayed on the touch screen when the portable telephone 1 is used in the horizontal direction. FIG. 5B is a view that shows an example of a screen that is displayed on the touch screen when the portable telephone 1 is used in the vertical direction. When “vertical direction” is selected as the display direction, as shown in FIG. 5B, the screen is displayed in the vertical direction (orientation at which the X direction in FIG. 1 is positioned in the vertical direction). When “horizontal direction” is selected as the display direction, as shown in FIG. 5A, the screen is displayed in the horizontal direction (orientation at which the X direction in FIG. 1 is positioned in the horizontal direction). Further, when “automatic” is selected as the display direction, the display direction is appropriately selected so that the acceleration direction is positioned at the lower side of the screen based on an acceleration direction that is detected by the acceleration sensor 26a. More specifically, when the portable telephone 1 is used in the horizontal direction as shown in FIG. 3A, a menu screen 33 that is long from side to side is displayed on the touch screen 11 as shown in FIG. 5A. In contrast, when the portable telephone 1 is used in the vertical direction as shown in FIG. 3B, a vertically long menu screen 33 is displayed on the touch screen 11 as shown in FIG. 5B.

In a case in which the usage state of the portable telephone 1 changes and the screen display direction is switched when the display direction is set to “automatic”, a vertically long screen is switched to a screen that is long from side to side, or a screen that is long from side to side is switched to a vertically long screen. Hence, a situation can be considered in which an area at which the user is gazing at that time is pushed out of the display area of the touch screen 11 and is no longer displayed. Therefore, the portable telephone 1 is equipped with a function such that when a usage state is to be changed, the user taps a position that the user is gazing at, and the screen is rotated by taking the tap position as an axis of rotation.

When the user wants to change the usage state with respect to the vertical or horizontal direction of the portable telephone 1, the user rotates the portable telephone 1 while tapping (or after tapping) a position that the user wants to use as the center of rotation on the touch screen 11. The portable telephone 1 rotates and displays the screen by taking the tapped position as the center of rotation. Thus, the user can intuitively change the screen display direction. At this time, a configuration may be adopted such that the user is caused to continue the tap operation during the rotation or in which the user taps once immediately prior to the rotation.

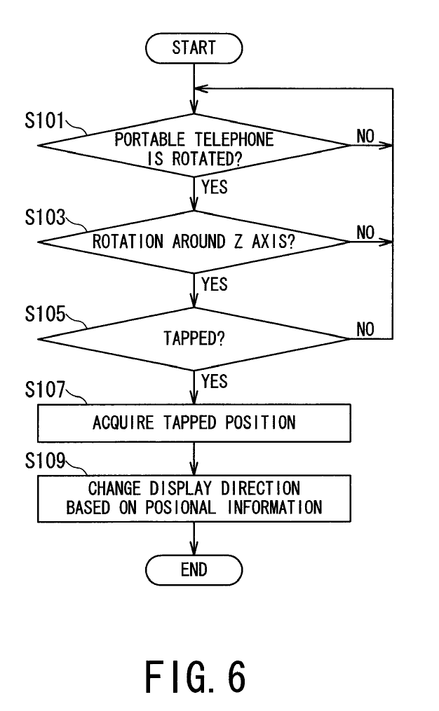

The procedures when the portable telephone 1 performs the screen direction control processing will now be described based on the flowchart shown in FIG. 6. In the following description the word “step” is omitted, for example as in the case of describing “step S101” as “S101”. In this connection, a case in which a screen according to, for example, the WVGA (Wide Video Graphics Array; 800×480 dots) standard is displayed on the touch screen 11 is described as an example.

First, the main control part 20 determines whether or not the portable telephone 1 has been rotated (S101). At this time, the main control part 20 determines that the portable telephone 1 has been rotated based on an acceleration detected by the acceleration sensor 26a. For example, when the portable telephone 1 has been rotated by a predetermined angle (for example, 90 degrees) or more around the Z axis shown in FIG. 1 or when the acceleration in the X-axis direction in FIG. 1 has been changed by a predetermined value or more, the main control part 20 determines that the portable telephone 1 has been rotated. If the portable telephone 1 has not been rotated (No in S101), the main control part 20 stands by in that state.

If the portable telephone 1 has been rotated (Yes in S101), the main control part 20 determines whether or not the rotation in step S101 is a rotation around the Z axis shown in FIG. 1 (S103). When the rotation is not a rotation around the Z axis (No in S103), since the usage state of the portable telephone 1 has not been changed from a horizontal orientation to a vertical orientation or from a vertical orientation to a horizontal orientation, control of the screen display is not performed and the main control part 20 returns to step S101 and stands by until the portable telephone 1 is rotated again.

When the rotation in step S101 is a rotation around the Z axis (Yes in S103), the main control part 20 determines whether or not the touch screen 11 is being tapped (S105). At this time, a determination regarding whether or not the touch screen 11 is being tapped may be one that determines whether or not the touch screen 11 has been tapped immediately before being rotated, or may be one that determines whether or not the touch screen 11 is being tapped in a continuous manner during rotation. When the touch screen 11 is not tapped (No in S105), more specifically, when the portable telephone 1 has been rotated without being tapped, the main control part 20 determines that an instruction to rotate the screen has not been intentionally given by the user. Hence, control of the screen display is not performed, and the main control part 20 returns to step S101 and stands by until the portable telephone 1 is rotated again.

In a case in which the touch screen 11 has been tapped when the portable telephone 1 is rotated around the Z axis (Yes in S105), the main control part 20 acquires information regarding the position at which the touch screen 11 has been tapped (S107). Subsequently, based on the positional information acquired in step S107, the main control part 20 changes the screen display direction to the vertical or horizontal direction (S109).

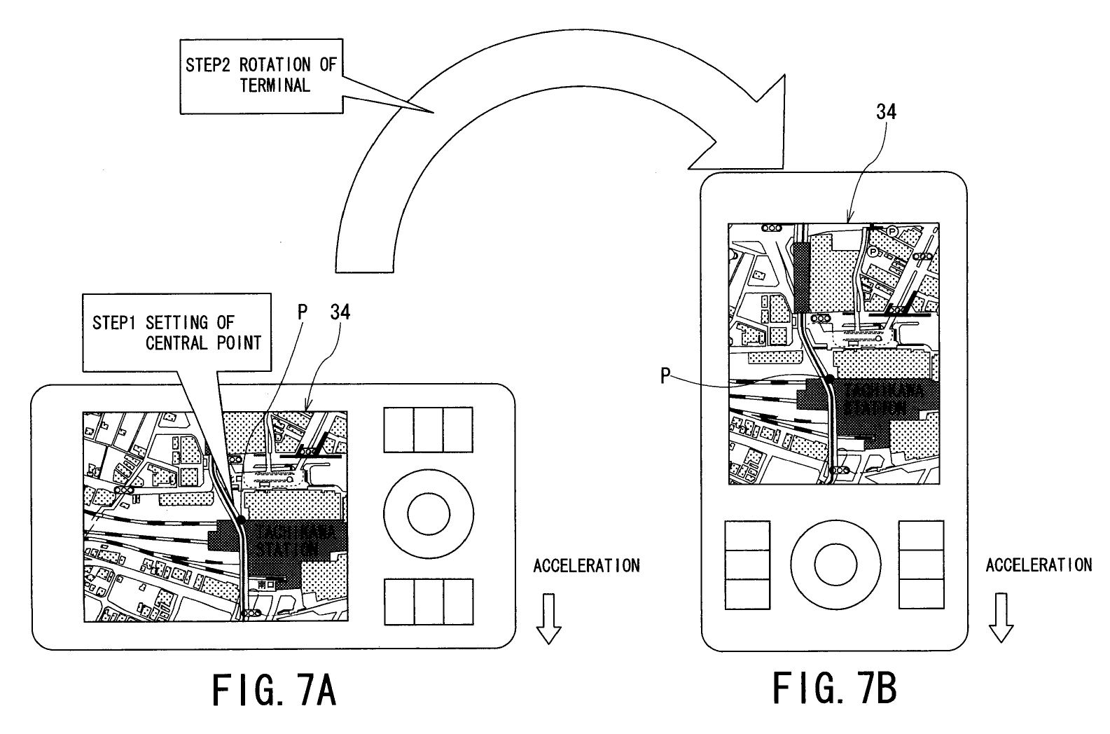

FIG. 7A is a view that shows an example of a screen when map information is displayed on the touch screen 11 in a state in which the portable telephone 1 is used in the horizontal direction. FIG. 7B is a view that shows an example of a screen when map information is displayed on the touch screen 11 in a state in which the portable telephone 1 is used in the vertical direction. For example, when the portable telephone 1 is first used in the horizontal direction as shown in FIG. 3A and map information is displayed on a screen that is long from side to side as shown in FIG. 7A, if the portable telephone 1 is rotated by 90 degrees, as shown in FIG. 3B, around an axis in the Z direction shown in FIG. 1, the map information is displayed on a vertically long screen as shown in FIG. 7B. At this time, if a position P on the screen shown in FIG. 7A has been tapped, as shown in FIG. 7B a display position that is being displayed at the position P on the screen is not changed, and the map information is rotated 90 degrees by employing the position P as the center of rotation and displayed.

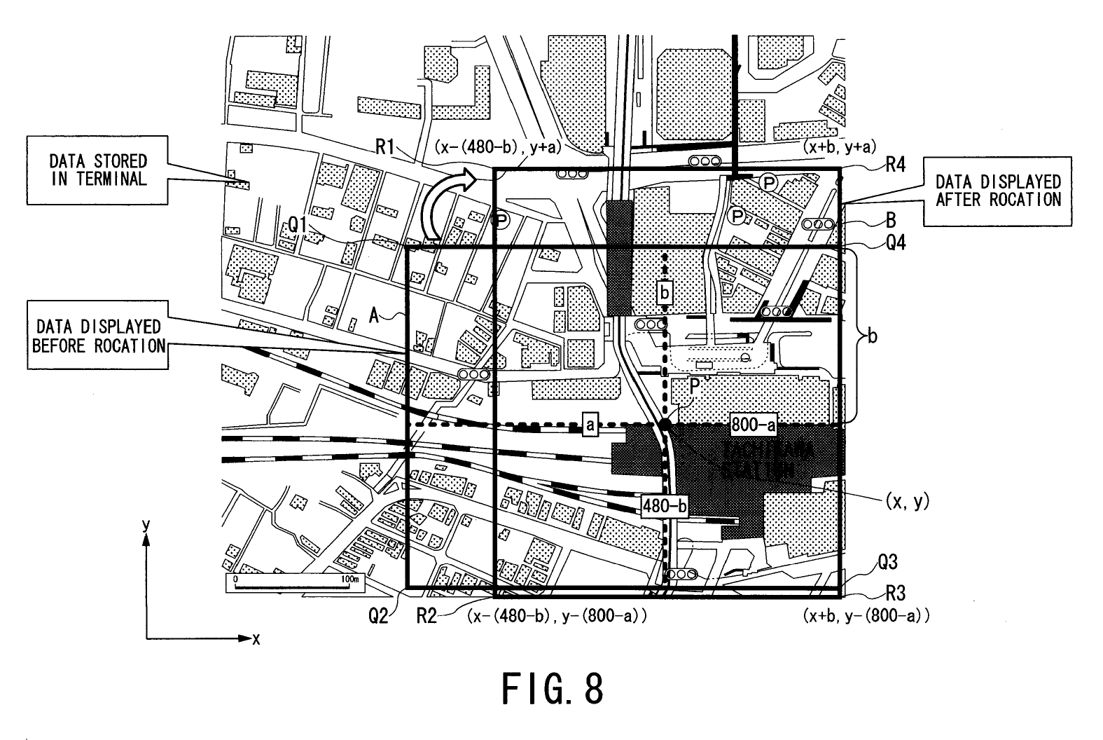

FIG. 8 is a view that shows, with respect to map information displayed on the touch screen 11, an example of an area A that is stored in the storage part 27 and displayed on the touch screen 11 when the portable telephone 1 is used in the horizontal direction, and an example of an area B that is displayed on the touch screen 11 when the portable telephone 1 is used in the vertical direction. In a case in which, for example, the portable telephone 1 is held at a horizontal orientation by the user and, as shown in FIG. 8, a rectangular area A surrounded by, for example, four points consisting of Q1(0, 480), Q2(0, 0), Q3(800, 0), and Q4(800, 480) is displayed on the touch screen 11, when the portable telephone 1 is rotated to a vertical orientation from the horizontal orientation while the position P on the touch screen 11 is tapped by the user, the portable telephone 1 calculates the coordinates of the data to be displayed after the rotation (more specifically, coordinates of data to be displayed in the display direction for the vertical orientation). If the coordinates on the screen at the tapped position are taken as (x, y), an area to be displayed on the touch screen 11 after rotation is a rectangular area surrounded by the four points R1 (x−(480−b), y+a), R2 (x+b, y+a), R3 (x−(480−b), y−(800−a)), and R4 (x+b, y−(800−a)) obtained by clockwise rotation from the left upper end on the screen. The portable telephone 1 utilizes data acquired by cutting out and rotating the map information of the area B as display data, and displays the data on the touch screen 11. In this connection, the numerical value “a” denotes a distance from the X coordinate of the tapped position P to the left side of the screen before rotation, and the numerical value “b” denotes a distance from the Y coordinate of the tapped position P to the upper side of the screen before rotation.

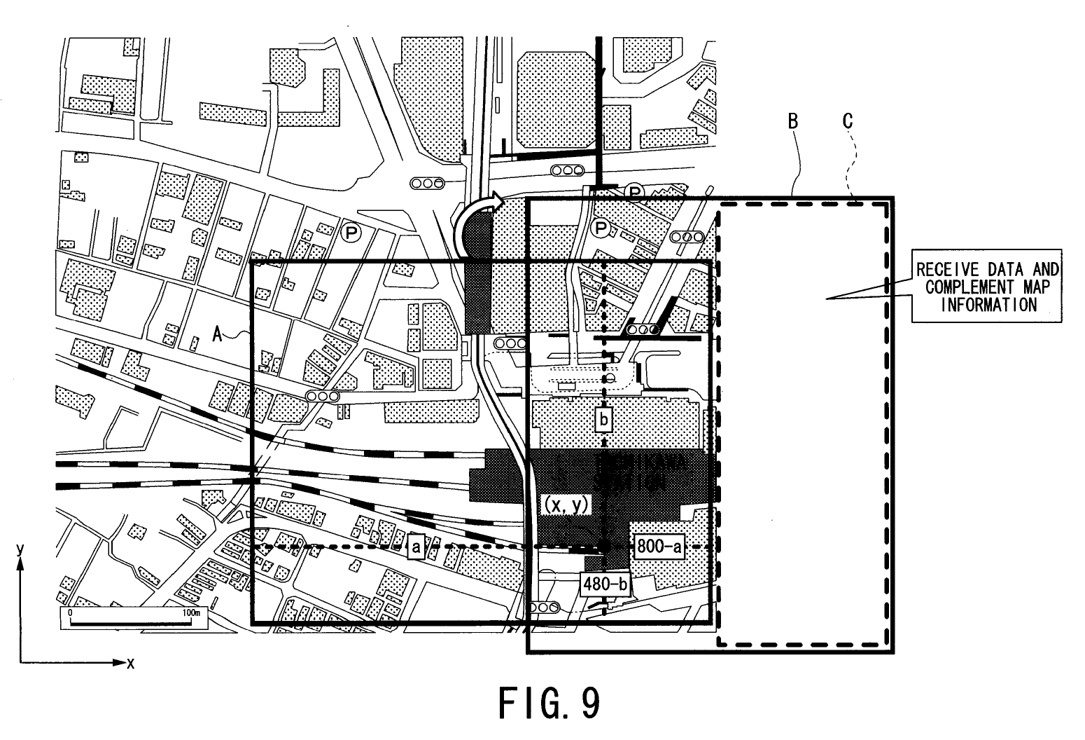

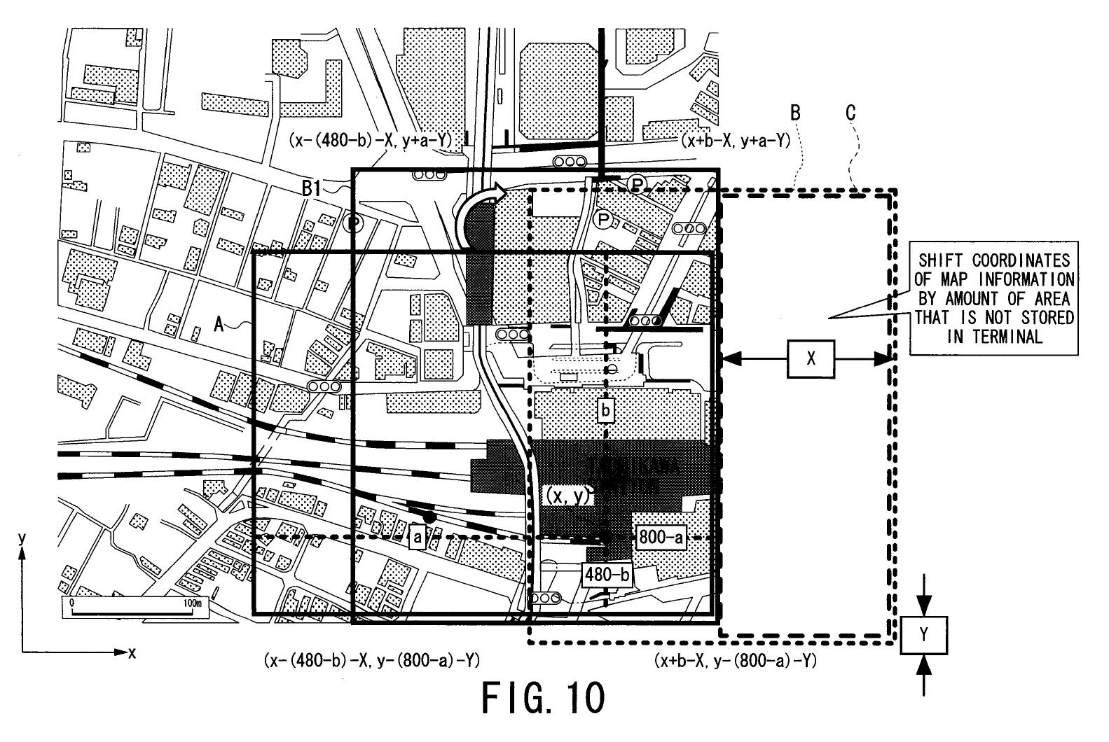

FIG. 9 and FIG. 10 are views that show, with respect to map information that is displayed on the touch screen 11, an example of an area A that is displayed on the touch screen 11 when the portable telephone 1 is used in the horizontal direction, and an example of an area B that is displayed on the touch screen 11 when the portable telephone 1 is used in the vertical direction. At the time of displaying map information on the touch screen 11, the portable telephone 1 displays the map information on the touch screen 11 based on map information of a fixed area that the portable telephone 1 previously stores in the storage part 27. The portable telephone 1 previously stores the map information by receiving map information via the communication control part 25 for each predetermined area.

However, in a case in which the portable telephone 1 is held, for example, at a horizontal orientation by the user and the rectangular area A is displayed on the touch screen 11 as shown in FIG. 9, if the portable telephone 1 is rotated from a horizontal orientation to a vertical orientation while the position P on the touch screen 11 is being tapped by the user, in some cases a portion (area C) of the area B after rotation in the map information may not be stored in the storage part 27. Therefore, when a portion (area C) of the display area B after rotation in the map information has not yet been received in a case in which the portable telephone 1 is receiving map information for each predetermined range through the communication control part 25 and is displaying that map information, it is sufficient to adopt a configuration such that the map information of area C is received through the communication control part 25 at the time of rotation and displayed.

Further, when the portable telephone 1 is, for example, held at a horizontal orientation by the user and the rectangular area A is displayed on the touch screen 11 as shown in FIG. 10, if the portable telephone 1 is rotated from the horizontal orientation to a vertical orientation while the position P on the touch screen 11 is being tapped by the user, a case may arise in which a portion (area C) of the area B after rotation in the map information is not stored in the storage part 27. In such case, a configuration may be adopted such that, for example, in accordance with an instruction of the user, an area obtained by shifting the coordinates by the amount of the area C that is not stored in the storage part 27 of the display area B after rotation is taken as a display area B1, and an area that results after cutting out the display area B1 from the stored map information and rotating the resulting area is utilized as display data and displayed on the touch screen 11.

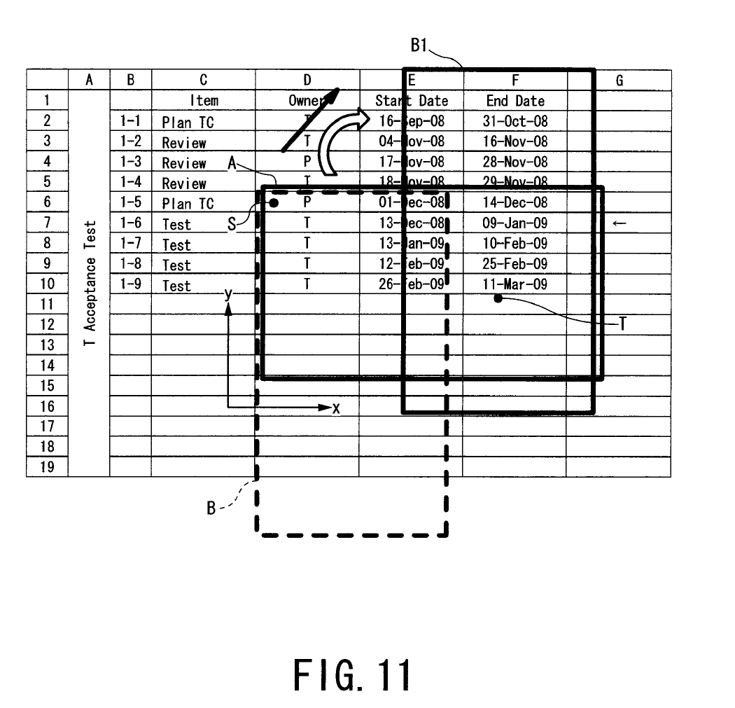

FIG. 11 is a view that shows, with respect to spreadsheet information, an example of an area A that is displayed on the touch screen 11 when the portable telephone 1 is used in the horizontal direction, and an example of an area B that is displayed on the touch screen 11 when the portable telephone 1 is used in the vertical direction. As shown in FIG. 11, when, for example, the usage state is changed from a horizontal orientation to a vertical orientation (or from a vertical orientation to a horizontal orientation) while the portable telephone is displaying spreadsheet information on the touch screen 11, normally an area B obtained by rotating the display contents by employing a cell S at the left upper end as the center of rotation is displayed after rotation, although the rotation and display also depend on the processing contents of the application. Hence, if the user has been working on the spreadsheet, there is a risk that a cell T that the user has been working on will no longer be displayed. Therefore, it is sufficient for the portable telephone 1 to display an area B1 obtained by shifting the coordinates of the spreadsheet information so that the cell T that the user is working on is displayed after rotation based on the cell T that the user is working on (or a cell at a position that is being tapped). In the example shown in FIG. 11, the display position is shifted by a difference between a cell D−6 and the cell T (cell F−11) that the user is working on, that is, the display position is shifted by 2 cells (=F−D) to the right and by 5 cells (=11−6) in the upward direction.

Thus, in a case in which the screen is being tapped when the usage state is changed from a vertical orientation to a horizontal orientation or from a horizontal orientation to a vertical orientation, the portable telephone 1 changes the screen display direction by employing the tap position as the axis of rotation. For example, in a case in which the user wants to know detailed map information regarding the direction in which the user is proceeding when a map is displayed horizontally on the touch screen 11, the user can display map information regarding the direction in which the user is proceeding by performing the simple operation of rotating the portable telephone 1 while tapping the touch screen 11. Therefore, for example, if a user wants to know detailed map information regarding the direction in which the user is proceeding when the user is holding the portable telephone 1 at a horizontal orientation and is viewing a map, the user can change the screen display direction simply by changing the orientation of the portable telephone 1 to a vertical orientation while specifying the center of rotation by tapping the screen.

Further, although a configuration may also be considered that changes the screen display direction using only the acceleration sensor 26a (by only detecting a rotation of the portable telephone 1), in that case there is the risk that the display direction will be changed against the intention of the user due to the portable telephone 1 swaying when the user is moving or the like. According to the portable telephone 1, by allowing the user to tap the touch screen 11 to decide an axis of rotation of the screen when changing the screen display direction, it is possible to prevent the screen display direction from being changed against the intention of the user.

Various user interfaces for functions such as tapping, dragging, displaying enlarged/reduced images and the like that utilize a touch screen have already been defined. However, according to the portable telephone 1, a novel user interface that rotates a screen based on a specified center of rotation can be provided.

According to the portable terminal (portable telephone 1) of the present invention, a screen display direction can be changed based on an acceleration. Further, by allowing the user to specify an axis of rotation when changing the screen display direction, it is possible to prevent a change that is against the intention of the user, and also to change the display direction in a state in which a portion that the user wants to display among the display contents remains displayed.

The portable telephone 1 is described above as an example of the present invention. However, the present invention is not limited to a portable telephone and may also be an arbitrary portable terminal as long as the portable terminal is a communication terminal equipped with a touch screen and a function that switches a screen display direction. Examples thereof include a PHS (Personal Handyphone System), a PDA (Personal Digital Assistant), a portable music player, a portable video camera, and a portable game machine.

What is claimed is:

1. A portable terminal, comprising:
a display unit configured to display data on a screen;
a rotation detecting unit configured to detect rotation of the portable terminal;
a touch detecting unit configured to detect touch of the screen of the display unit; and
a display control unit configured to, when rotation is detected by the rotation detecting unit and touch is detected by the touch detecting unit, revolve display content displayed on the screen in conformity with the rotation of the portable terminal.

2. A portable terminal according to claim 1, comprising a position detecting unit configured to, when touch is detected by the touch detecting unit, detect touched position of the screen, wherein
the display control unit revolves the display content displayed on the screen about the touched position detected by the position detecting unit, when rotation is detected by the rotation detecting unit and touch is detected by the touch detecting unit.

3. The portable terminal according to claim 2, wherein the rotation detecting unit detects rotation of the portable terminal by detecting acceleration of the portable terminal.

4. The portable terminal according to claim 2, comprising:
a storage unit configured to store map information;
an acquiring unit configured to, when a portion of the map information displayed on the screen after rotation of the portable terminal is not stored by the storage unit, acquire shortfall of map information; wherein
the display control unit creates the display content displayed by the display unit using the map information stored by the storage unit or acquired by the acquiring unit when revolving the display content.

5. The portable terminal according to claim 2, comprising a storage unit configured to store map information, wherein
the display control unit shifts display range on the map information stored by the storage unit, when the map information is displayed by the display unit and a portion of the map information displayed on the screen after rotation of the portable terminal is not stored by the storage unit.

6. The portable terminal according to claim 2, wherein
the display control unit, when table calculation information is displayed by the displayed unit and the portable terminal is rotated, creates display content including an edited cell.

7. A display control method for a portable terminal, comprising:
a rotation detecting step for detecting rotation of the portable terminal;
a touch detecting step for detecting touch of a screen of the portable terminal; and
a setting step making a setting as to whether a connection is permitted to be established at the communication step, on the basis of the state acquired at the acquiring step; and
a display control step for, when rotation is detected at the rotation detecting step and touch is detected at the touch detecting step, revolving display content displayed on the screen in conformity with the rotation of the portable terminal.

8. The display control method for the portable terminal according to claim 7, comprising a position detecting step for, when touch is detected at the touch detecting step, detecting touched position of the screen, wherein
at the display control step, the display content displayed on the screen is revolved about the touched position detected at the position detecting step, when rotation is detected at the rotation detecting step and touch is detected at the touch detecting step.

9. The display control method for the portable terminal according to claim 8, wherein rotation of the portable terminal is detected by being detected acceleration of the portable terminal at the rotation detecting step.

10. The display control method for the portable terminal according to claim 8, comprising an acquiring step for, when map information is displayed on the screen and a portion of the map information displayed on the screen after rotation of the portable terminal is not stored in the portable terminal, acquiring shortfall of map information; wherein
display content displayed on the screen is created using the map information stored in the portable terminal or acquired at the acquiring step when the display content is revolved at the display control step.

11. The display control method for the portable terminal according to claim 8, wherein
when the map information is displayed on the screen and a portion of the map information displayed on the screen after rotation of the portable terminal is not stored in the portable terminal, display range on the map information is shifted at the display control step.

12. The display control method for the portable terminal according to claim 8, wherein
when table calculation information is displayed on the screen and the portable terminal is rotated, display content including an edited cell is created at the display control step.

13. A portable terminal, comprising:
a display means for displaying data on a screen;
a rotation detecting means for detecting rotation of the portable terminal;
a touch detecting means for detecting touch of the screen of the display means; and
a display control means for, when rotation is detected by the rotation detecting means and touch is detected by the touch detecting means, revolving display content displayed on the screen in conformity with the rotation of the portable terminal.

14. A portable terminal according to claim 13, comprising a position detecting means for, when touch is detected by the touch detecting means, detecting touched position of the screen, wherein
the display control means revolves the display content displayed on the screen about the touched position detected by the position detecting means, when rotation is detected by the rotation detecting means and touch is detected by the touch detecting means.

15. The portable terminal according to claim 14, wherein the rotation detecting means detects rotation of the portable terminal by detecting acceleration of the portable terminal.

16. The portable terminal according to claim 14, comprising:
a storage means for storing map information;
an acquiring means for, when a portion of the map information displayed on the screen after rotation of the portable terminal is not stored by the storage means, acquiring shortfall of map information; wherein
the display control means creates the display content displayed by the display means using the map information stored by the storage means or acquired by the acquiring means when revolving the display content.

17. The portable terminal according to claim 14, comprising a storage means for storing map information, wherein
the display control means shifts display range on the map information stored by the storage means, when the map information is displayed by the display means and a portion of the map information displayed on the screen after rotation of the portable terminal is not stored by the storage means.

18. The portable terminal according to claim 14, wherein
the display control means, when table calculation information is displayed by the displayed means and the portable terminal is rotated, creates display content including an edited cell.
